(19) United States
(12) Patent Application Publication
(10) Pub. No.: US 2013/0111030 A1
(43) Pub. Date: May 2, 2013

(54) Method of Handling Access Right and Related Communication Device

(71) Applicant: HTC Corporation, Taoyuan County (TW)

(72) Inventors: Chun-Ta Yu, Taoyuan County (TW); Yin-Yeh Tseng, Taoyuan County (TW)

(73) Assignee: HTC CORPORATION, Taoyuan County (TW)

(21) Appl. No.: 13/664,440

(22) Filed: Oct. 31, 2012

Related U.S. Application Data
(60) Provisional application No. 61/553,922, filed on Oct. 31, 2011.

(51) Int. Cl. G06F 15/173

(52) U.S. Cl. 709/225

(57) ABSTRACT

A method of representing access right for a service system comprising a device management (DM) client and a DM server is disclosed. The method comprises mapping a first access right to a first power of 2; and mapping a second access right to a second power of 2, wherein the second access right is different from the first access right, if the second power of 2 is different from the first power of 2.

### CROSS REFERENCE TO RELATED APPLICATIONS

This application claims the benefit of U.S. Provisional Application No. 61/553,922, filed on Oct. 31, 2011 and entitled “Efficient method for access control system in OMA Device Management”, the contents of which are incorporated herein in their entirety.

### BACKGROUND OF THE INVENTION

1. Field of the Invention

The present invention relates to a method used in a service system and related communication device, and more particularly, to a method of handling access right and related communication device.

2. Description of the Prior Art

Open Mobile Alliance (OMA) is founded to develop OMA specifications for mobile services to meet users' needs. Furthermore, the OMA specifications aim to facilitate providing of the mobile services which are interoperable across geographic areas (e.g. countries), operators, service providers, networks, operation systems and mobile devices. In detail, the mobile services conforming to the OMA specifications can be used by the users without being restricted to particular operators and service providers. The mobile services conforming to the OMA specifications are also bearer agnostic, i.e., the bearer that carries the mobile services can be a second generation (2G) mobile system such as Global System for Mobile Communications (GSM), Enhanced Data rates for GSM Evolution (EDGE) or General Packet Radio Service (GPRS), or a third generation (3G) and beyond mobile system such as Universal Mobile Telecommunications System (UMTS), Long Term Evolution (LTE) or LTE-Advanced (LTE-A). Further, the mobile services conforming to the OMA specifications can be executed on various operation systems such as Windows, Android or Linux operated on various mobile devices. Therefore, industries providing the mobile devices or the mobile services supporting the OMA specifications can benefit from a largely growing market enabled by interoperability of the mobile services. Besides, the users use the mobile devices or the mobile services supporting the OMA specifications can also have a better experience due to the interoperability of the mobile services.

In OMA Device Management (DM) requirement, a DM server is defined as an authorized legal entity which can manage one or more DM clients (e.g. mobile devices) by using a DM protocol conforming to the OMA specifications. In detail, the DM protocol defines a way according to which a packet, a message and/or a package (i.e., a combination of multiple messages transmitted in a same direction) is exchanged between the DM server and the DM client. The DM protocol also defines a way according to which the DM client can feedback a command, a status or a report to the DM server. Further, when using the DM protocol, the DM server manages the DM client through a set of management objects in the DM client, wherein each management object may include one or more nodes. A management object may be small as an integer or large as a picture. Besides, the management object may conform to the DM protocol such as a Software Component Management Object (SCOMO), a Software and Application Control Management Object (SACMO) or a Firmware Update Management Object (FUMO).

In the DM 1.x Protocol, an access control list (ACL) of a node (e.g., an interior node or a leaf node) is used for listing DM servers having one or more access rights of the node. In detail, there are five access rights: Add, Delete, Replace, Exec and Get which correspond to an Add command, a Delete command, a Replace command, an Exec command and a Get command (i.e., DM commands), respectively. For example, DM servers having access rights of Get of a node can retrieve (i.e., get) content of the node. The content of the node can be data (e.g., value) of the node when the node is a leaf node, or can be a child list of the node when the node is an interior node. However, except the content of the node, a DM server with the access right of Get can also retrieve the ACL of the node. That is, it is difficult to protect the ACL, since we cannot give the access right of retrieving the content of the node to the DM server without the access right of retrieving the ACL.

Besides, a rule for changing the ACL of the node is complex. For the interior node, the DM server needs to have the access right of Replace to change the ACL of the interior node. For the leaf node, the DM server can change the ACL of the node, if the DM server has the access right of Replace of the node's parent node or the node's ancestor node. Thus, it is complicated and time-consuming to change the ACL of the node. Moreover, a string for describing (i.e., representing) an access right is long, and is hard to be managed in the DM 1.x protocol. The representation of the access right should be improved. Therefore, improving the structure and the description of the access right is a topic to discussed and addressed.

### SUMMARY OF THE INVENTION

The present invention therefore provides a method and related communication device for handling access right to solve the abovementioned problem.

A method of representing access right for a service system comprising a device management (DM) client and a DM server is disclosed. The method comprises mapping a first access right to a first power of 2; and mapping a second access right to a second power of 2, wherein the second access right is different from the first access right, if the second power of 2 is different from the first power of 2.

A method of handling access right for a device management (DM) client in a service system is disclosed. The method comprises receiving a DM command from a DM server of the service system, for the DM server to execute the DM command on a node in the DM client; determining that the DM command is valid according to an access right corresponding to the DM command, when the node is a leaf node and the DM command is an Exec command; and determining that the DM command is valid according to the access right corresponding to the DM command, when the node is an interior node and the DM command is an Add command.

A method of handling access right for a device management (DM) client in a service system is disclosed. The method comprises receiving a DM command from a DM server of the service system, for the DM server to execute the DM command on a node in the DM client; determining that the DM server can only execute the DM command on content of the node, when the DM server has a first access right of the DM command for the node; and determining that the DM server can only execute the DM command on an access control list of the node, when the DM server has a second access right of the DM command for the node.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a service system according to an example of the present invention.

FIG. 2 is a schematic diagram of a communication device according to an example of the present invention.

FIG. 3 is a flowchart of a process according to an example of the present invention.

FIG. 4 is a flowchart of a process according to an example of the present invention.

FIG. 5 is a flowchart of a process according to an example of the present invention.

### DETAILED DESCRIPTION

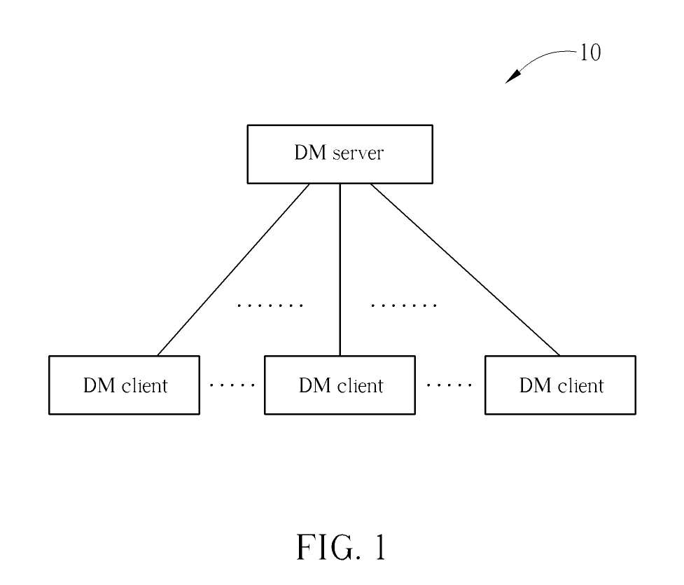

Please refer to FIG. 1, which is a schematic diagram of a service system 10 according to an example of the present invention. The service system 10 is briefly composed of a device management (DM) server and a plurality of DM clients supporting the DM 1.x protocol or its later versions developed by Open Mobile Alliance (OMA). A DM client maintains access control list(s) (ACL) which comprises access rights corresponding to one or more DM servers. The access rights may be related to management objects in the DM client, or may be related to nodes (e.g., an interior node and/or a leaf node) in the DM client. In detail, when a DM server intends to execute a DM command on a node in the DM client, the DM client determines whether the execution is allowed (i.e., valid) according to the access rights in the ACL. The DM command may be anyone of an Add command, a Delete command, a Replace command, an Exec command or a Get command corresponding to the access rights of Add, Delete, Replace, Exec and Get, respectively. The DM server can execute the DM command on the node if the DM server has the access right of to DM command. For example, the DM server can perform the Add command on an interior node, if the DM server has the access right of Add of the interior node.

In FIG. 1, the DM clients and the DM server are simply utilized for illustrating a structure of the service system 10. Practically, the DM clients can be installed in desktops and home electronics which are fixed at a certain position. Alternatively, the DM clients can be installed in mobile devices such as mobile phones, laptops, tablet computers, electronic books, and portable computer systems. The service system can be bearer agnostic, i.e., the bearer used for exchanging information (e.g., message, request, response, package, etc.) between the DM clients and the DM server can be a second generation (2G) mobile system such as Global System for Mobile Communications (GSM), Enhanced Data rates for GSM Evolution (EDGE) or General Packet Radio Service (GPRS), a third generation (3G) and beyond mobile system such as Universal Mobile Telecommunications System (UMTS), Long Term Evolution (LTE) system or LTE-Advanced system, or even a wireline communication system such as an Asymmetric Digital Subscriber Line (ADSL).

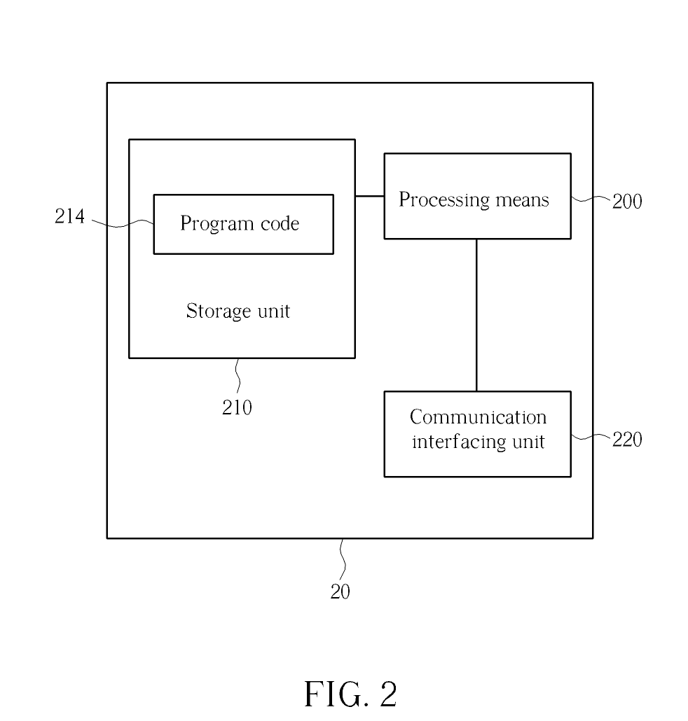

Please refer to FIG. 2, which is a schematic diagram of a communication device 20 according to an example of the present invention. The communication device 20 can be devices wherein a DM client or the DM server shown in FIG. 1 is installed. The communication device 20 may include a processing means 200 such as a microprocessor or an Application Specific Integrated Circuit (ASIC), a storage unit 210 and a communication interfacing unit 220. The storage unit 210 may be any (non-transitory) computer-readable storage medium that can store a program code 214, accessed by the processing means 200. Examples of the storage unit 210 include but are not limited to a subscriber identity module (SIM), read-only memory (ROM), flash memory, random-access memory (RAM), CD-ROM/DVD-ROM, magnetic tape, hard disk, and optical data storage device. The communication interfacing unit 220 is preferably a transceiver, and can transmit/receive information (e.g., message, request, response, package, etc.) according to processing results of the processing means 200.

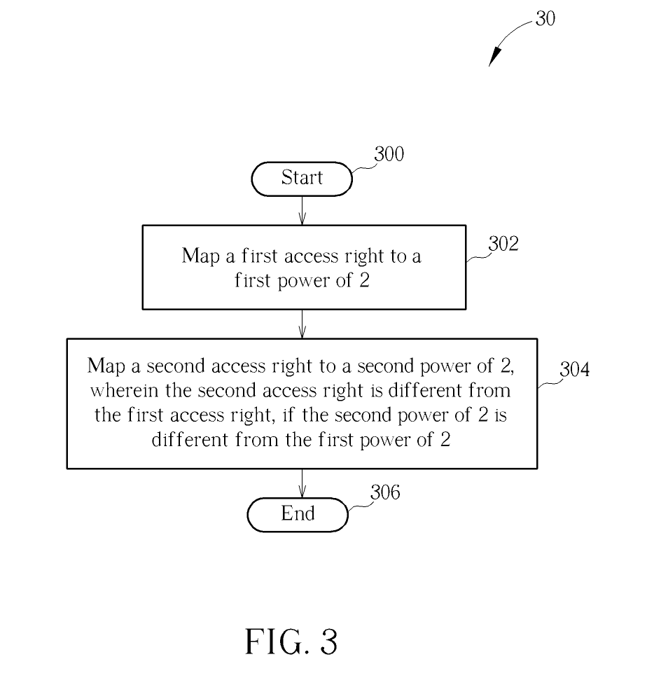

Please refer to FIG. 3, which is a flowchart of a process 30 according to an example of the present invention. The process 30 is utilized in the service system 10, i.e., the DM clients and/or the DM server shown in FIG. 1, for representing (e.g., describing, mapping, encoding/decoding) access right. The process 30 may be compiled into the program code 214 and includes the following steps:

Step 300: Start.

Step 302: Map a first access right to a first power of 2.

Step 304: Map a second access right to a second power of 2, wherein the second access right is different from the first access right, if the second power of 2 is different from the first power of 2.

Step 306: End.

According to the process 30, a first access right is mapped to (i.e., represented by) a first power of 2. Then, a second access right is mapped to a second power of 2, wherein the second access right is different from the first access right, if the second power of 2 is different from the first power of 2. When a third access right is further considered, the third access right is mapped to a third power of 2, wherein the third access right is different from the first access right and the second access right, if the third power of 2 is different from the first power of 2 and the second power of 2. Thus, when the DM server is configured with an access right, a number mapped to the access right can be used to simplify the description (i.e., representation).

For example, the access rights of Add, Delete, Replace, Exec and Get can be mapped to (i.e., represented by) 1, 2, 4, 8 and 16, respectively. When the DM server has the access right of Replace, “Replace=DM server” is configured (e.g., in the ACL) according to the prior art. However, “4=DM server” can be configured according to the present invention, to obtain a simpler representation. Further, when the DM server is configured with (i.e., has) the first access right and the second access right, the DM server is configured with a sum of the first power of 2 and the second power of 2. For example, when the DM server has the access right of Add, Delete and Exec, “Add=DM server&Delete=DM server&Exec=DM server” is configured (e.g., in the ACL) according to the prior art. However, “11=DM server” can be configured according to the present invention, since the sum of 1, 2 and 8 is 11, wherein 11 is a value and may be stored in other encoding format (e.g., Hex format or Binary format). Thus, a simpler representation for the DM server with multiple access rights is obtained. Besides, a sum of values of the powers of 2 can be easily identified (i.e., realized) by performing an “And” operation. For example, after the DM client performs the “And” operation on an ACL value and 8, the DM client grants the Exec access right if the result is 1.

Thus, according to the process 30 and the above description, representations (i.e., mappings, descriptions) of an access right can be easily performed by the DM server and/or the DM client, to simplify maintenance (e.g., add, modify and/or delete) of the access right.

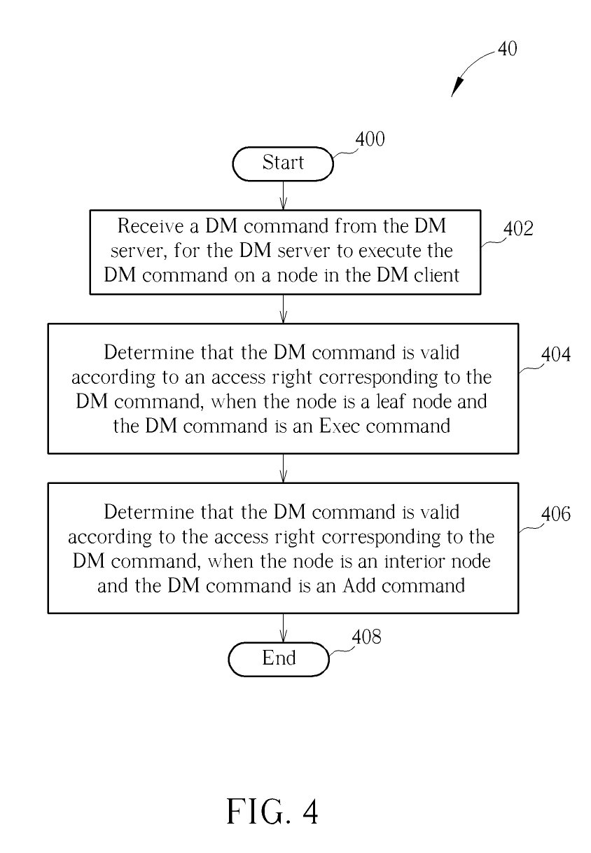

Please refer to FIG. 4, which is a flowchart of a process 40 according to an example of the present invention. The process 40 is utilized in a DM client shown in FIG. 1, for handling access right for the DM server. The process 40 may be compiled into the program code 214 and includes the following steps:

Step 400: Start.

Step 402: Receive a DM command from the DM server, for the DM server to execute the DM command on a node in the DM client.

Step 404: Determine that the DM command is valid according to an access right corresponding to the DM command, when the node is a leaf node and the DM command is an Exec command.

Step 406: Determine that the DM command is valid according to the access right corresponding to the DM command, when the node is an interior node and the DM command is an Add command.

Step 408: End.

According to the process 40, after receiving a DM command from the DM server, i.e., the DM server intends to execute the DM command on a node in the DM client, the DM client determines that the DM command is valid according to an access right corresponding to the DM command, when the node is a leaf node and the DM command is an Exec command, and determines that the DM command is valid according to the access right corresponding to the DM command, when the node is an interior node and the DM command is an Add command. That is, the Add command and the Exec command are verified via the same access right, e.g., a new access right AE, which can be a combination of the access rights of Add and Exec. Thus, only four access rights of AE, Delete, Replace and Get are needed for the five DM commands including the Add command, the Delete command, the Replace command, the Exec command and the Get command. As a result, a number of the access rights need to be managed is reduced.

Furthermore, the access rights of Add, Replace and Exec can be combined into an access right, to further reduce the number of the access rights. In detail, the DM client determines that the DM command is valid according to the access right corresponding to the DM command when the node is the leaf node and the DM command is the Exec command or a Replace command, and determines that the DM command is valid according to the access right corresponding to the DM command, when the node is the interior node and the DM command is the Add command or the Replace command. That is, whether the Exec command, the Add command and the Replace command are verified via the same access right, e.g., a new access right ARE, which can be a combination of the access rights of Add, Replace and Exec. Thus, only three access rights of ARE, Delete and Get are needed for the five DM commands including the Add command, the Delete command, the Replace command, the Exec command and the Get command. As a result, a number of the access rights needed to be managed is further reduced.

Please note that, if the DM client determines that the DM command is not valid according to the access right corresponding to the DM command, the DM client can report an error to the DM server, to notify that the DM server is not allowed to execute the DM command on the node. Besides, the access rights mentioned above can also be mapped to powers of 2 according to the process 30 and related description, to simplify the representation of the access rights.

Thus, according to the process 40 and the above description, the access rights can be managed and checked more easily since the number of the access rights is reduced.

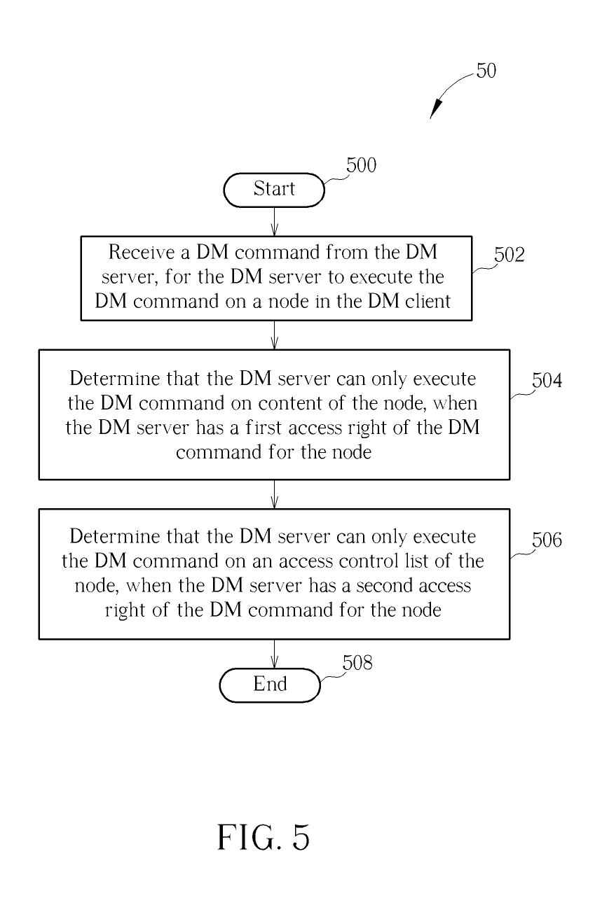

Please refer to FIG. 5, which is a flowchart of a process 50 according to an example of the present invention. The process 50 is utilized in a DM client shown in FIG. 1, for handling access right for the DM server. The process 50 may be compiled into the program code 214 and includes the following steps:

Step 500: Start.

Step 502: Receive a DM command from the DM server, for the DM server to execute the DM command on a node in the DM client.

Step 504: Determine that the DM server can only execute the DM command on content of the node, when the DM server has a first access right of the DM command for the node.

Step 506: Determine that the DM server can only execute the DM command on an access control list of the node, when the DM server has a second access right of the DM command for the node.

Step 508: End.

According to the process 50, after receiving a DM command from the DM server, i.e., the DM server intends to execute the DM command on a node in the DM client, the DM client determines that the DM server can only execute the DM command on content of the node when the DM server has a first access right of the DM command for the node, and determines that the DM server can only execute the DM command on an ACL of the node, when the DM server has a second access right of the DM command for the node. In other words, the first access right and the second access right are used for managing the content and the ACL of the node for a single DM command, respectively. Thus, the problem that the DM server which can execute the DM command on the content can also execute the DM command on the ACL is solved. As a result, the ACL can be protected, and security of the node is improved. Note that the access rights mentioned above can also be mapped to powers of 2 according to the process 30 and related description, to simplify the representation of the access rights.

Preferably, the DM command mentioned above can be a Replace command or a Get command. In detail, two access rights Rep1 and Rep2 are used for the Replace command, wherein the access rights Rep1 and Rep2 are used for managing the content and the ACL of the node, respectively. That is, the DM server can only perform the Replace command on the content of the node if the DM server has the access right Rep1, and the DM server can only perform the Replace command on the ACL of the node if the DM server has the access right Rep2. Similarly, two access rights Get1 and Get2 are used for the Get command, wherein the access rights Get1 and Get2 are used for managing the content and the ACL of the node, respectively. That is, the DM server can only perform the Get command on the content of the node if the DM server has the access right Get1, and the DM server can only perform the Get command on the ACL of the node if the DM server has the access right Get2.

Please note that, the access rights Rep1, Rep2, Get1 and Get2 can be newly defined access rights, and original access rights corresponding to the Replace command and the Get command are disabled. Alternatively, the access rights Rep1 and Get1 can be newly defined access rights, and the original access rights corresponding to the Replace command and the Get command are modified for (e.g., restricted to) managing only the ACL of the node. In another example, the access rights Rep2 and Get2 can be newly defined access rights, and the original access rights corresponding to the Replace command and the Get command are modified for (e.g., restricted to) managing only the content of the node.

Thus, according to the process 50 and the above description, the ACL can be managed and accessed under an improved protection, since the access right for the content and the ACL of the node are separated into two access rights.

Those skilled in the art should readily make combinations, modifications and/or alterations on the abovementioned examples. The abovementioned steps of the processes including suggested steps can be realized by means that could be a hardware, a firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include a system on chip (SOC), system in package (SiP), a computer on module (COM), and the communication device 20.

To sum up, the present invention provides a method for handling access rights. According to the present invention, the access rights can be represented (i.e., mapped, described, encoded/decoded) efficiently. Besides, the access rights can be maintained simply and securely.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of representing access right for a service system comprising a device management (DM) client and a DM server, the method comprising:
mapping a first access right to a first power of 2; and
mapping a second access right to a second power of 2, wherein the second access right is different from the first access right, if the second power of 2 is different from the first power of 2.

2. The method of claim 1, further comprising:
mapping a third access right to a third power of 2, wherein the third access right is different from the first access right and the second access right, if the third power of 2 is different from the first power of 2 and the second power of 2.

3. The method of claim 1, wherein the DM server is configured with a sum of the first power of 2 and the second power of 2, when the DM server is configured with the first access right and the second access right.

4. The method of claim 1, wherein the first access right corresponds to a first DM command, and the second access right corresponds to a second DM command.

5. The method of claim 1, wherein each of the first power of 2 and the second power of 2 is represented in a decimal format, a binary format or a hex format.

6. A method of handling access right for a device management (DM) client in a service system, the method comprising:
receiving a DM command from a DM server of the service system, for the DM server to execute the DM command on a node in the DM client;
determining that the DM command is valid according to an access right corresponding to the DM command, when the node is a leaf node and the DM command is an Exec command; and
determining that the DM command is valid according to the access right corresponding to the DM command, when the node is an interior node and the DM command is an Add command.

7. The method of claim 6, further comprising:
determining that the DM command is valid according to the access right corresponding to the DM command, when the node is the leaf node and the DM command is the Exec command or a Replace command; and
determining that the DM command is valid according to the access right corresponding to the DM command, when the node is the interior node and the DM command is the Add command or the Replace command.

8. The method of claim 6, further comprising:
reporting an error to the DM server, after determining that the DM command is not valid according to the access right corresponding to the DM command.

9. The method of claim 6, wherein the access right is mapped to a power of 2.

10. A method of handling access right for a device management (DM) client in a service system, the method comprising:
receiving a DM command from a DM server of the service system, for the DM server to execute the DM command on a node in the DM client;
determining that the DM server can only execute the DM command on content of the node, when the DM server has a first access right of the DM command for the node; and
determining that the DM server can only execute the DM command on an access control list of the node, when the DM server has a second access right of the DM command for the node.

11. The method of claim 10, wherein the DM command is a Replace command or a Get command.

12. The method of claim 10, wherein the access right is mapped to a power of 2.
